(19) United States
(12) Patent Application Publication
(10) Pub. No.: US 2002/0164998 A1
(43) Pub. Date: Nov. 7, 2002

(54) System and method for providing position-based information to a user of a wireless device

(76) Inventor: Saed Younis, Giza (EG)

Correspondence Address: Sarah Kirkpatrick, Intellectual Property Administration, QUALCOMM Incorporated, 5775 Morehouse Drive, San Diego, CA, 92121-1714, US

(21) Appl. No.: 10/008,309

(22) Filed: Nov. 8, 2001

Related U.S. Application Data
(60) Provisional application No. 60/287,901, filed on May 1, 2001.

(51) Int. Cl. H04Q 7/20

(52) U.S. Cl. 455/456; 455/422

(57) ABSTRACT

In a wireless network including a base station, an application server, a position determining entity and a mobile phone, a method for using the mobile phone as a vehicle navigation device. The mobile phone detects a user activated request for driving directions and establishes voice and data communications links with the application server through the base station. The user vocally transmits the request and a destination location to the application server. Using wireless assisted GPS, the mobile phone determines its position and transmits its position to the position determining entity. The mobile phone receives the requested driving directions from the application server through the data communications link and provides audible driving directions to the user. In operation, the application server receives the request for position-related information, retrieves the position of the mobile phone from the position determining entity and processes the request for information in accordance with the position of the wireless device.

### RELATED APPLICATIONS

This application claims priority to U.S. Provisional Application No. 60/287,901, filed on May 1, 2001.

### BACKGROUND OF THE INVENTION

1. Field of the Invention

The disclosed method and apparatus relates generally to position determination systems and, more specifically, to systems and methods for providing position-based information to a user of a wireless device.

2. Description of the Related Art

Systems for determining the geographic position of a wireless device are well known in the art. A commonly used position determination system is the Global Positioning System (GPS) operated by the United States Department of Defense. The GPS includes a network of 24 satellites that orbit the earth in six circular planes. The GPS satellites are spaced so that, at any given time and from any geographic position, at least five GPS satellites will be above the horizon. In operation, each GPS satellite continually broadcasts its present position and current time. On earth, a GPS receiver may use the information contained in these broadcast signals to compute its geographic position in terms of its longitude, latitude and altitude. The GPS receiver typically searches for and collects the signals broadcast from four GPS satellites that are in view. Next, using the time interval between the broadcast time and reception time of each broadcast signal, the GPS receiver calculates the distance between the GPS receiver and each of the four GPS satellites. These distance measurements, along with the position and time information received in the broadcast signals, allow the GPS receiver to calculate its geographic position with an accuracy of less than 100 meters.

It is well known that the performance of a GPS receiver (e.g., accuracy of calculated position and signal acquisition time) can be significantly improved when integrated with a wireless communication network having a stationary GPS receiver. For example, in an approach known as differential GPS a base station having a stationary GPS receiver is maintained at a known position. The base station compares its GPS-calculated position to its known position and derives differential correction data for the GPS satellites in view to correct for detected errors in its GPS-calculated position. Errors in the GPS-calculated position may be caused by atmospheric and tropospheric conditions, errors in the satellite data, reception errors and other error sources. The differential correction data is transmitted to mobile GPS receivers in the base station's coverage area. By using the differential correction data in its GPS position calculations, a GPS receiver can determine its geographic position with an accuracy of less than 10 meters.

In another approach, the mobile GPS receiver receives aiding information through a local base station to assist the mobile GPS receiver in locating the broadcast signals from the GPS satellites that are in view. The base station continually tracks the positions of the GPS satellites that are in view and transmits the identities and positions of these GPS satellites, along with other aiding information such as the associated Doppler frequencies of the broadcast signals, to GPS receivers in the base station's coverage area. The aiding information informs the GPS receiver of the approximate location of the GPS satellites in view, thereby narrowing the required search window and significantly reducing the amount of time needed to acquire the GPS broadcast signals. Unassisted, the process of searching for four GPS satellite broadcast signals can take minutes because most mobile GPS receivers lack accurate GPS satellite position information and, thus, lack information on where to look for the satellites. Examples of wireless communications systems that assist GPS systems are disclosed in U.S. Pat. No. 6,058,338, entitled “METHOD AND APPARATUS FOR EFFICIENT GPS ASSISTANCE IN A COMMUNICATION SYSTEM,” assigned to assignee, and U.S. Pat. No. 5,999,124, entitled “SATELLITE POSITIONING SYSTEM AUGMENTATION WITH WIRELESS COMMUNICATION SIGNALS,” assigned to SnapTrack, Inc.

The increased speed, accuracy and availability of GPS receivers has led to the proliferation of a variety of applications and services for providing position-based information to users of mobile systems. Such applications and services are commonly implemented in navigation systems. One known navigation system is mounted in a vehicle and includes an onboard computer, a GPS receiver for determining the position of the vehicle, memory for storing map and road information (e.g., a CD-ROM), an input device and a visual display device for displaying a map of a current vehicle position. In operation, the position of the vehicle is calculated by the GPS receiver and provided to the onboard computer which retrieves a local map from the memory and displays the local map on the visual display device.

Many vehicle navigation systems are also adapted to determine an optimum route to travel between two geographic positions. The driver specifies a starting position (typically the current vehicle position) and identifies a destination. The onboard computer will then recommend one or more routes to the destination and can provide the driver with a set of driving directions for reaching the destination. The navigation system may also track the vehicle's progress along the selected route and provide the driver with directions via the display device and/or voice prompts.

The onboard vehicle navigation systems described above have many drawbacks. For example, these vehicle navigation systems typically include a local data storage for storing detailed map and road data, including speed limits, street names and address ranges, points-of-interest and the location of services such as restaurants and gas stations. The local data storage has limited capacity (often limited to a single metropolitan area or region) and the stored information becomes quickly out-dated as new buildings and roads are constructed, businesses change locations and other position-based information is changed. Some navigation systems avoid these problems by downloading updated map information from a central database through a wireless communications link. However, this technique requires large and frequent downloads of display and position-related information and is not practical in current vehicle navigation systems. Another disadvantage is that these vehicle navigation systems are costly and require installation in the vehicle. Because these systems cannot be used away from the vehicle, a separate navigation system must be purchase for use while walking, riding a bicycle or other mobile activities.

Some prior art vehicle navigation systems connect the driver to a live operator at a remote service center that provides the driver with the requested information. For example, a driver may contact the service to request the name and telephone number of a hotel that is nearest to the driver's current position. The operator obtains GPS position data from a wireless telecommunication device that is part of the vehicle navigation system. The operator then receives the driver's verbal request for information, offers suggestions to meet the driver's request and verbally provides the requested information to the driver. Similar to the systems described above, these vehicle navigation systems are expensive and cannot be used away from the vehicle. In addition, these vehicle navigation systems require the driver to be engaged in a conversation with the operator to audibly receive the requested information.

Although many modern mobile devices, such as mobile phones, pagers and personal digital assistants (PDAs), have been adapted to operate as GPS receivers, these devices typically include small screens and cumbersome menu interfaces and provide applications and services that are not suitable for use while driving a vehicle.

In view of the numerous drawbacks in the prior art, there is a need for an improved position determination system that is capable of providing various position application services, such as vehicle navigation. The system should be capable of use both in and away from the vehicle, and should not require the purchase of a dedicated hardware device. Finally, the system should be capable of providing reliable, up-to-date position-based information to the user.

### SUMMARY OF THE INVENTION

An improved system and method for providing position-related information to users of wireless devices in disclosed herein. In one embodiment, a wireless communications system includes a plurality of base stations and a plurality of wireless devices, such as mobile telephones and personal digital assistants, adapted to communicate with base stations. The wireless communications system further includes a position determination system for determining the geographic position of the wireless devices. A data processor, such as a position determination entity (PDE) connected to the base stations, serves as the processing site for computing the position of the wireless devices.

The wireless communications system also includes an application server for providing position-related information and services to users of the wireless devices. When the application server detects a call from a wireless device, the application server activates a voice-activated menu which audibly provides the user with a set of service/information options. The user may verbally interact with the voice-activated menu to select and request position-related information. Through a separate data communications link, the application server retrieves the current position of the wireless device from the PDE. After the user's request is identified, the data processor retrieves the requested position-related information and transmits the position-related information to the wireless device across a data communications link.

In accordance with one embodiment, the wireless device includes a position application interface for managing a user's request for position-related information and at least one application module for processing the requested data. The application modules may include navigation applications, yellow pages applications, sightseeing applications, and other applications that use position-related data. The position application interface may interact with the standard hardware and software components of the wireless device, including a position determination system and speech synthesis components.

In one embodiment, the position determination system is a GPS receiver and the wireless device is adapted to receive GPS assistance from the PDE. The user may activate the application interface by pressing a key on the keypad of the wireless device, dialing a predetermined telephone number or through another user activated input method of the wireless device. Once activated, the position application interface in cooperation with the position determining system, determines the current geographic position of the wireless device and establishes a voice communications link between the wireless device and the application server. Through the voice communications link, the user may verbally request position-related information. The requested position-related information is received at the wireless device through a data communications link. The information received may include any position-related information, such as information related to the geographical position of the wireless device, including: driving directions; local points of interest; addresses; telephone numbers of telephones located nearby; menus for local restaurants; and coupons and advertisements for local establishments. The received position-related information is stored in a local memory and processed by an associated application module. In accordance with one embodiment, the application module audibly presents the position-related information to the user through an earpiece or speaker of the wireless device.

In another embodiment of the disclosed method and apparatus, a wireless network includes a base station, an application server, a PDE and at least one mobile phone. The mobile phone detects a user initiated request for navigation information and establishes voice and data communications with the application server through the base station. The mobile phone determines its geographic position in collaboration with the PDE. Navigation information is received by the mobile phone through the data communications link and the mobile phone audibly presents the position-related information, including driving directions, to the user of the mobile phone.

In another embodiment of the disclosed method and apparatus, an application server receives a request for position-related information through a voice communications link with a wireless device. The geographic position of the wireless device is received from a position determination entity through a data communications link. Next, the application server processes the request in accordance with the geographic position of the wireless device to produce position-related information. The position-related information is then transmitted to the wireless device through a data communications link.

A more complete understanding of the System and Method for Providing Position-Based Information to a User of a Wireless Device will be afforded to those skilled in the art, as well as a realization of additional advantages and objects thereof, by a consideration of the following detailed description of several embodiments. Reference will be made to the appended sheets of drawings, which will first be described briefly.

### BRIEF DESCRIPTION OF THE DRAWINGS

FIG. 1 is a bock diagram illustrating a wireless communications system in accordance with one embodiment of the disclosed method and apparatus;

FIG. 2 is a block diagram illustrating a one of the possible means of operation of the wireless communications system;

FIG. 3 is a block diagram illustrating an application server in accordance with one embodiment of the disclosed method and apparatus;

FIG. 4 is a flow diagram illustrating one possible means of operation of the application server;

FIG. 5 is a block diagram illustrating a wireless device in accordance with one embodiment of the disclosed method and apparatus; and

FIG. 6 is a flow diagram illustrating one of the possible means of operation of the wireless device.

### DETAILED DESCRIPTION OF EMBODIMENTS OF THE DISCLOSED METHOD AND APPARATUS

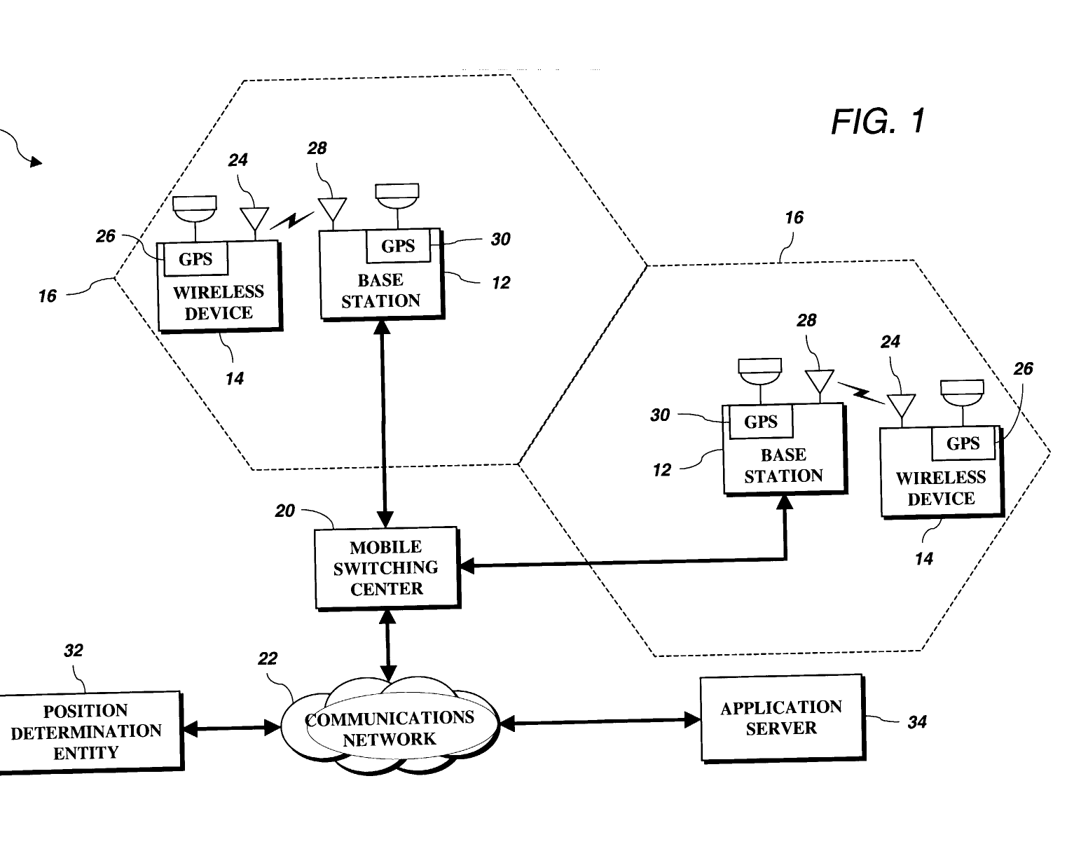

A system and method for providing position-related information to a user of a wireless device is disclosed herein. FIG. 1 illustrates a wireless communications system 10 in accordance with one embodiment of the disclosed method and apparatus. The wireless communications system 10 is shown as a cell-based communication system including a plurality of base stations 12 and a plurality of wireless devices 14. Each base station 12 has an associated cell 16 defining a geographical coverage area serviced by the base station 12. Each wireless device 14 positioned within one of the cells 16 communicates with the associated base station 12 by exchanging data packets according to a predetermined digital communications protocol, such as code division multiple access (CDMA). The wireless devices 14 may be any devices capable of communicating with the base stations 12 over a wireless communications link, including mobile telephones, personal digital assistants (PDAs), vehicle navigation systems and portable computers.

A mobile switching center (MSC) 20 manages the wireless communications in the cells 16, including call set-up, routing calls between wireless devices and routing calls between wireless devices and at least one communications network 22, such as a public switched telephone network (PTSN) or the Internet. It will be appreciated that the wireless communications system 10 may include a plurality of MSCs, each managing a plurality of cells 16. In alternate embodiments, the wireless communications system may be any wireless system that is adapted to transmit data to and from a mobile device, including terrestrial or satellite based cellular communications systems such as a cellular telephone system, a personal communication system, a specialized mobile radio system, an Advanced Mobile Phone System, a pager system and a wireless packet data system, a wireless local area network, a personal local area network, or any other such wireless communications network. In addition, it will be appreciated by those skilled in the art that the information may be communicated by means other than the communication of digital packets of data. Any means by which intelligence may be communicated from a server to a wireless device would be sufficient to support the present invention.

The wireless communications system 10 is further adapted to determine the geographic position of at least one wireless device 14. Any position determination system that produces a geographic location of wireless devices may be used, including systems that calculate the distances between a wireless device and two or more base stations using the time difference of signals sent between the wireless device and the base stations, and satellite positioning systems such as the Global Positioning System (GPS). In one embodiment, each wireless device 14 includes a cellular communications antenna 24 and a GPS receiver 26, and each base station 12 includes a cellular communications antenna 28 and a GPS receiver 30. The wireless device 14 receives GPS signals transmitted from orbiting GPS satellites through the GPS receiver 26 and communicates with the base station 12 through the antenna 24. The base station 12 communicates with the wireless device 14 through the antenna 28, and receives GPS signals for its position through the GPS receiver 30. A position determination entity (PDE) 32 is connected to the base station 12 through the MSC 20 and serves as the processing site for computing the geographic position of the wireless device 14. The PDE 26 is a server, or network of servers, that tracks the location of the GPS satellites using a plurality of stationary GPS receivers placed at known geographic positions, such as the GPS receivers 30 placed at each base station 12 or stationary GPS receivers scattered throughout the system's area of coverage. The PDE 26 provides aiding information to mobile GPS receivers, such as GPS receivers 26, within the coverage range of the wireless communications system 10.

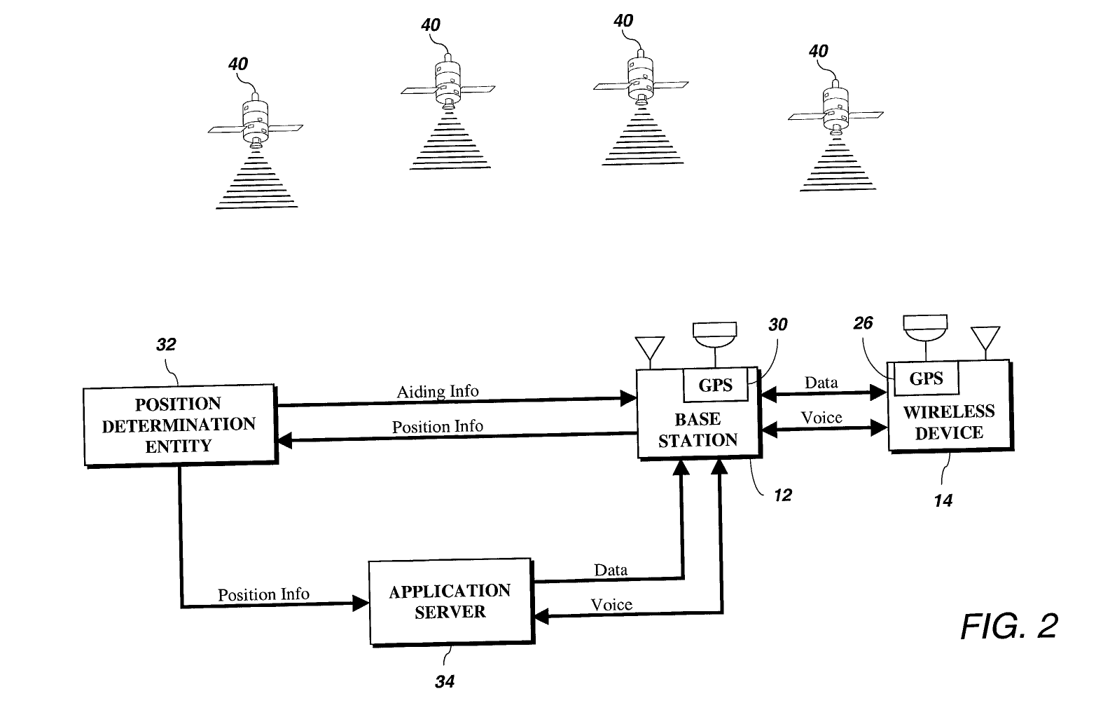

One process for determining the geographic position of a wireless device will now be described with reference to the block diagram of FIG. 2. The PDE 32 continually tracks the positions of a plurality of GPS satellites 40 through the GPS receiver 30, and maintains current information on each of the GPS satellites 40 in view. This information includes satellite identification information, GPS timing information and each satellite's elevation angle, Doppler frequency and pseudorange. The PDE 32 also derives differential correction data for the GPS satellites 40 to correct for detected errors in the GPS signals received at the GPS receiver 30.

The process for determining the geographic position of the wireless device 14 may be initiated by the user of the wireless device 14. In alternate embodiments, the position determination process may also be initiated by the base station 12, the PDE 32, the MSC 20 or another device or entity connected to or part of the wireless communications system 10. After the position determination process is initiated, the wireless device 14 requests GPS aiding information from the PDE 32 through the base station 12. The PDE 32 identifies the GPS satellites 40 that are in view of the GPS receiver 30 and, with respect to the GPS receiver 30, determines the current position, the Doppler frequencies and pseudoranges of each of the identified GPS satellites 40 at specific GPS times. This GPS aiding information is transmitted to the wireless device 14 through the base station 12. Because the wireless device 14 is in communication with, and therefore proximate to, the base station 12, this GPS aiding information provides the wireless device 14 with the approximate positions of the GPS satellites 40 in view, significantly reducing the search frequency range for the GPS satellite signals. Once the GPS satellite signals are acquired, the geographic position of the wireless device 14 may be determined in accordance with methods well-known in the art.

In one embodiment, the position of the wireless device 14 is determined in accordance with gpsOne™ position location technology, developed by assignee. Using gpsOne™ technology, the wireless device 14 simultaneously collects measurements from at least one GPS satellite 40 and at least one base station 12 and transmits the information to the PDE 32, which carries out accurate position calculations using the data previously collected by the PDE 32. By combining the collected data, the PDE 32 can determine the position of the wireless device 14 using as few as one GPS satellite 40 and one base station 12. Examples of GPS position determination systems in wireless communications networks are disclosed in U.S. Pat. No. 6,058,338, entitled “METHOD AND APPARATUS FOR EFFICIENT GPS ASSISTANCE IN A COMMUNICATION SYSTEM” and U.S. Pat. No. 6,081,229, entitled “SYSTEM AND METHOD FOR DETERMINING THE POSITION OF A WIRELESS CDMA TRANSCEIVER,” both assigned to assignee, and U.S. Pat. No. 6,133,874, entitled “METHOD AND APPARATUS FOR ACQUIRING SATELLITE POSITIONING SYSTEM SIGNALS,” assigned to SnapTrack, Inc.

After the position of the wireless device 14 is determined, position-related information and services can be provided to the user of the wireless device 14. Position-related information and services may include driving directions, the location of local merchants, and emergency services. In one embodiment, position-related information and services are provided by an application server 34, which is coupled to both the PDE 32 and the MSC 20 through at least one communications network 22 (see FIG. 1).

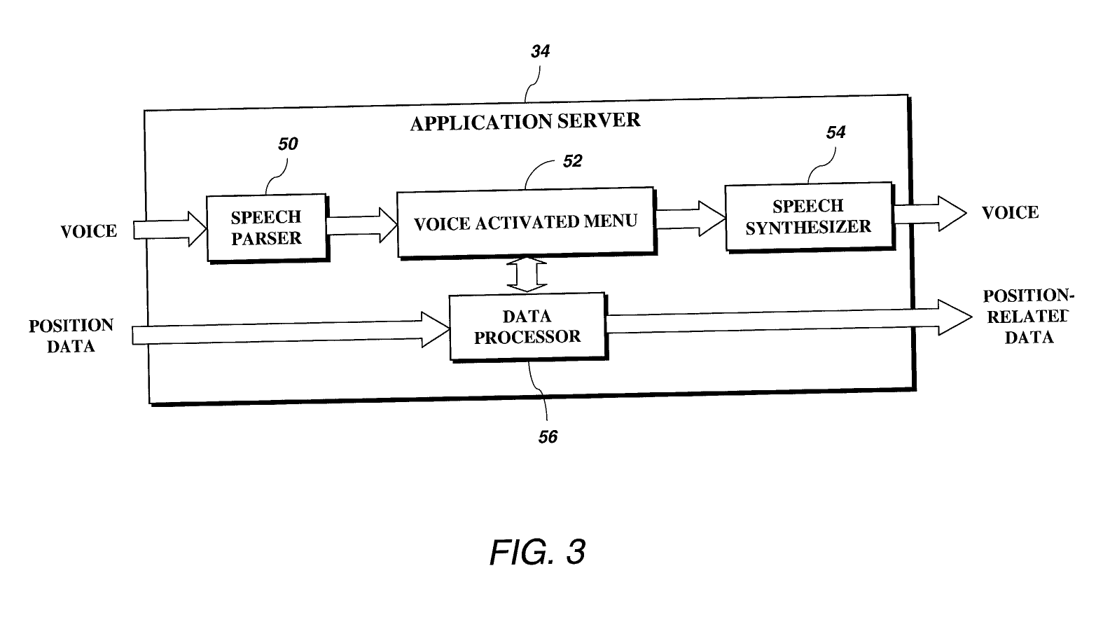

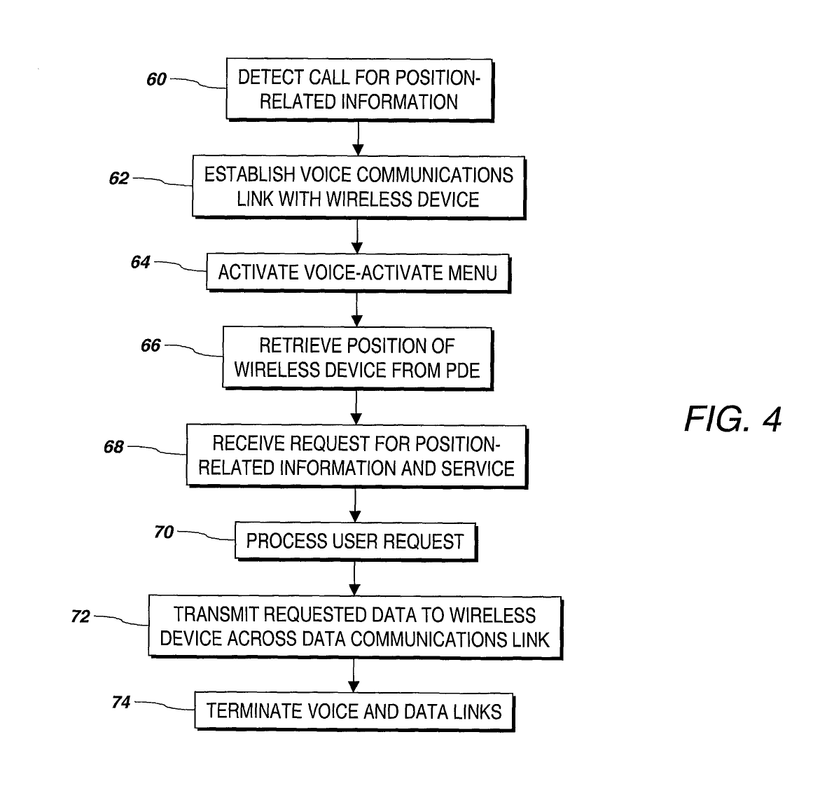

As illustrated in the functional block diagram of FIG. 3, the application server 34 may include a speech parser 50, a voice-activated menu 52, a speech synthesizer 54 and a data processor 56. The operation of the application server 34 will now be described with reference to the flow diagram of FIG. 4. A request for position-related information or services is typically received at the MSC 20 (FIG. 1) in the form of a telephone call from a wireless device 14. The MSC 20 routes the call to the application server 34 through the communications network 22 (FIG. 1). In step 60, the application server 34 detects the call from the wireless device 14, and a voice communications link with the wireless device 14 is established in step 62. In one embodiment, the voice communications link is a conventional telephone connection using the PTSN, but it will be appreciated that any voice communications connections and protocols and can be used, such as voice-over-IP across an Internet connection. In step 64, the application server 34 activates the voice-activated menu 52 which provides the user with a set of service/information options. In operation, the initial set of options are determined, converted to speech by a speech synthesizer 54 and output to the wireless device 14 through the voice communications link. The menu options are presented to the user through a speaker on the wireless device 14, and the user may verbally respond with a menu selection or information request. The user's verbal response is forwarded to the speech parser 50, which processes the speech for use by the voice-activated menu 52.

The voice-activated menu 52 of one embodiment provides a simple automated solution to processing a request for position-related information. The application server 34 will typically handle a limited number of position-related services (e.g., navigation, yellow pages, movie times) and the types of position-related information requested by the user will be further limited by the information requested (e.g., address and telephone number of a local seafood restaurant). Because the contexts are limited, the speech parser 50 will stress a limited context-based vocabulary. In addition, the limited contexts allow the voice-activated menu 52 to efficiently process the user's request even if the speech parser 50 cannot identify a user's verbal selection. For example, it is contemplated that the voice-activate menu will present questions to the user to narrow the context when the voice-activated menu 52 does not understand a user request (e.g., “Do you want driving directions?”). In step 66, the application server 34 retrieves the position of the wireless device 14 from the PDE 30. The position data is forwarded to the data processor 56 for use with the voice-activated menu 52 to provide the user with position-based menu options. Because the user's requests may include street names, business names and other position-related information, the position data may also be used by the speech parser 50 to identify local vocabulary that would likely be used in the user's request.

After the application server 34 identifies the user's request in step 68, the data processor 56 retrieves the requested position-related information and processes the request in step 70 (e.g., determine driving directions between current position and a destination address). In step 72, the requested position-related information is transmitted to the wireless device 14 across a data communications link. After the requested position-related data is transmitted, the voice and data communications links are terminated in step 74, and the application server 34 waits for the next request for position-related information. It will be appreciated that the voice communications link may be terminated before the requested position-related data is transmitted.

It should be noted that in an alternative embodiment of the disclosed method and apparatus, the application server does not have a speech parser 50 or voice activated menus. Rather, a human operator processes the verbal request and enters the request manually. The request is then provided from the operator's input device, such as a conventional keyboard, mouse, or touch screen, to the data processor 56 within the application server 34.

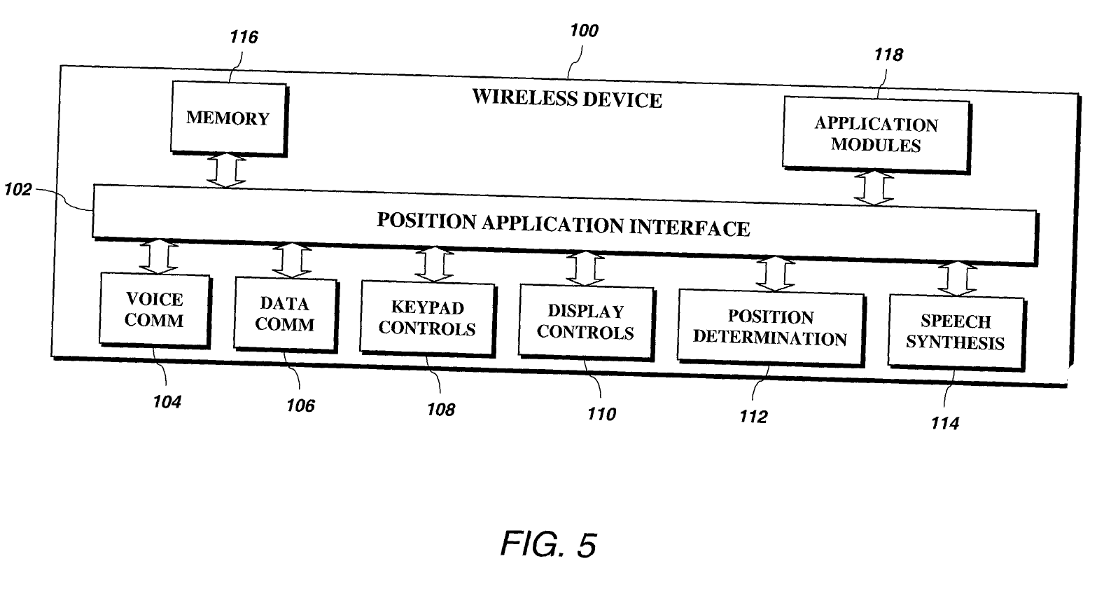

One embodiment of a wireless device will now be described with reference to the functional block diagram of FIG. 5. The wireless device 100 of FIG. 5 includes a position application interface 102 for managing a user's request for position-related information and at least one application module 118 for processing the requested data. The application modules 118 may include navigation applications, yellow pages applications, sightseeing applications, and other applications that use position data.

In one embodiment, the position application interface 102 is a software component that interacts with the standard hardware and software components of the wireless device 100, including voice communications components 104 for establishing a voice communications path with a base station 12 in the wireless communications system 10, data communications components 106 for establishing a data communications path with a base station 12, keyboard control components 108 for receiving user input, display components 110 for visually displaying data to the user, and position determination components 112 for determining the geographic position of the wireless device 100.

In one embodiment, the position of the wireless device 100 is determined using a satellite position location system such as GPS, and the position determination components 112 are further adapted to receive aiding information from the PDE 32. In an alternate embodiment, the position determination components 112 calculate the position of the wireless device 100 without the assistance of the PDE 32. The wireless device 100 also includes speech synthesis components 114 for producing audible speech through an earpiece or speaker of the wireless device 100. It will be appreciated that many wireless devices, such as conventional mobile phones, already include digital signal processors that can process simple speech synthesis. In one embodiment, a limited vocabulary is stored in a memory 116 of the wireless device 100 for use by the application modules 118 while processing position-related information for the user. For example, simple phrases such as “turn right” or “turn left” may be stored for use in a navigation application within the position application interface.

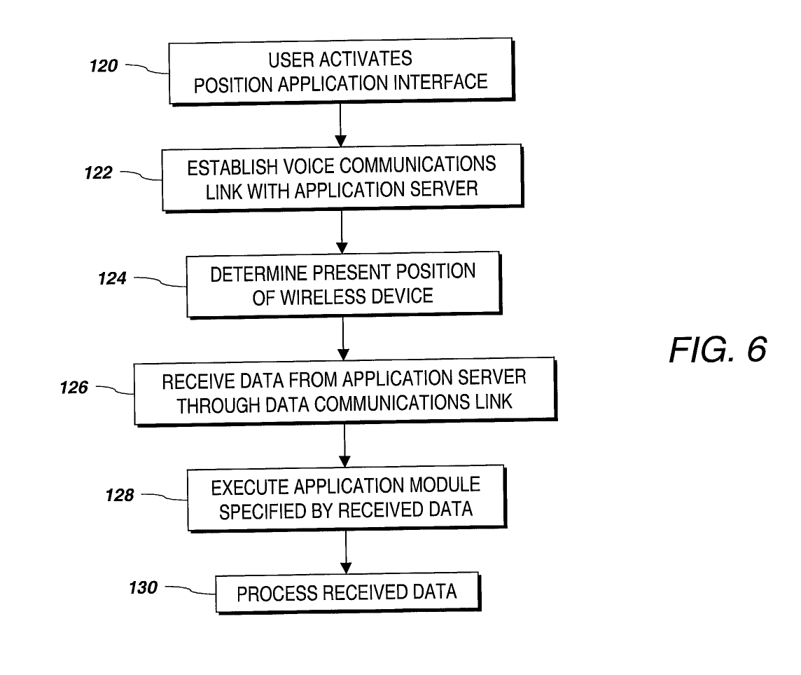

One means of operation of a position application interface 102 will now be described with reference to the flow diagram of FIG. 6. In step 120, the user activates the position application interface 102. In one embodiment, a key on the keypad of the wireless device 100 is programmed to activate the position application 102 when depressed. In alternate embodiments, the wireless device 100 may be programmed to activate the application upon the recognition of a predetermined sequence of dialed numbers (e.g., “3-1-1” or “4-1-1”), upon the selection of a menu option presented to the user on the display, or through another user input method. In step 122, the position application interface 102 establishes a voice communications link with the application server 34 using the voice communication components 104 of the wireless device 100. Through the voice communications link, the user can vocally request position-related information from the application server 34 or an operator. The position application interface 102 determines the current geographical position of the wireless device 100 in step 124 using the position determination components 112.

In step 126, the requested position-related information is returned to the wireless device 100 through a data communications link. The received data may include any information that is related to the geographical position of the wireless device 100 including driving directions, points of interest, addresses, telephone numbers, menus for local restaurants and coupons and advertisements for local establishments. In one embodiment, the received data also includes a header to identify the data type (e.g., directions, advertisements) and an associated application module 118 for processing the received data. In step 128, the position application interface 102 reads the received data and launches the associated application module 118.

The received data is processed by the associated application module 118 in step 130. In one embodiment, the application modules 118 include a navigation application module that provides driving directions to the user of the wireless device 100. In operation, the directions are received from the application server 34 and stored in the memory of the wireless device 100. The navigation application module monitors the geographic position and velocity of the wireless device 100 through the position determination components 112 and prompts the user of approaching turns by sending a voice command to the speech synthesis components 72 of the wireless device 100, which output an audible prompt through the speaker of the wireless device 100. The navigation application module continues execution until the wireless device reaches the destination location, the user causes program termination (e.g., by depressing a button on the keypad), or through other events that cause program termination.

In an alternative embodiment of the disclosed method and apparatus, a connection between the wireless device 100 and the application server 34 is maintained until a predetermined portion of the information is provided to the wireless device 100. For example, in the case in which the user of the wireless device 100 has requested driving directions from an operator, the operator requests the directions directly from the application server 34. The application server 34 then responds by transmitting a portion of the directions to the wireless device 100. The portion of the directions may be only those directions which the application server 34 calculates would be required by the user in the next 5 minutes of driving, or only the next decision point (i.e., the next point at which the user needs to make a decision to alter course). The application server 34 can retain the communication link to the wireless device, getting information from the wireless device 100 sufficient to allow the application server 34 to track the location of the wireless device 100. Once the application server 34 detects that the user has altered course as instructed, the application server 34 downloads the next portion of the directions. However, if the user of the wireless device 100 has not executed the previously downloaded directions properly, the application server 34 can provide an updated next instruction to put the user back on course. In cases in which the application server 34 determines that the time between course altering decisions is relatively long, the communication link between the application server 34 and the wireless device 100 can be temporarily broken. The application server 34 may calculate the period of time until the user will execute the previously downloaded instruction. At the end of that calculated time period, the application server 34 reestablishes the communication link (such as by calling the user). Once the link is reestablished, the application server 34 checks the location of the wireless device 100 to esure that the user has properly executed the last instruction. If so, then the application server 34 downloads the next instruction to the wireless device 100. If not, then the application server 34 updates the instructions based on the current location of the wireless device 100 and provides the instructions to the wireless device 100, either one decision at a time, or in its entirety.

Having thus described one embodiment of the System and Method for Providing Position-Based Information to a User of a Wireless Device, it should be apparent to those skilled in the art that certain advantages of the within described system have been achieved. It should also be appreciated that various modifications, adaptations, and alternative embodiments thereof may be made within the scope and spirit of the present invention. For example, the present invention may be used to enhance the services offered through standard “4-1-1” operator service. The user of the wireless device 100 could be connected directly to a human operator who would process the user request at a terminal coupled to an application server, and cause the requested information to be downloaded directly to the wireless device 100. In another contemplated embodiment, the wireless device 100 is adapted to forward the data received from the application server to a second device, such as a vehicle onboard computer, which processes the received data.

The scope of the present invention is defined by the following claims.

1. In a wireless communications system, a method for providing a user of a wireless device with position-based information comprising the following steps:
receiving a user request for position-based information across a first communications link;
determining a geographic position of the wireless device;
processing the user request using the received geographic position to produce the requested position-based information; and
transmitting the requested position-based information to the wireless device across a second communications link.

2. The method of claim 1 wherein the first communications link is a voice communications link with the wireless device and the received request is a voice request.

3. The method of claim 2 wherein the second communications link is a data communications link with the wireless device.

4. The method of claim 3 wherein the wireless communications system includes a position determination entity and the step of determining a geographic position comprises the step of receiving the geographic position of the wireless device from the position determination entity across a third communications link.

5. The method of claim 2 further comprising the step of converting the voice request to a machine readable form.

6. The method of claim 5 further comprising the step of, before the step of receiving the user request, transmitting a selection menu to the wireless device across the first communications link.

7. The method of claim 6 further comprising the step of transmitting unrequested position-based information to the wireless device across the second communications link.

8. The method of claim 6 wherein the received user request is for navigation instructions to a destination position.

9. The method of claim 8 wherein the wireless device is mobile telephone.

10. In a wireless network including an application server and a mobile phone, a method for using the mobile phone as a navigation device, comprising the following steps:
establishing a voice communications link with the application server for vocally transmitting a destination position to the application server;
receiving the requested navigation information from the application server through a data communications link; and
presenting the user with the requested navigation information.

11. The method of claim 10 further comprising the steps of:
determining a current geographic position of the mobile phone; and
transmitting the current geographic position to the application server.

12. The method of claim 10 wherein the step of presenting comprises the following steps:
converting the requested navigation information to speech; and
audibly presenting the speech to user through a speaker on the mobile phone.

13. The method of claim 10 further comprising the step of detecting a user request for navigation information.

14. The method of claim 13 wherein the step of detecting a user request comprises the steps of:
associating the user request for navigation information with a predetermined telephone number; and
detecting a call to the predetermined telephone number.

15. The method of claim 10 wherein the step of receiving is completed before the step of presenting.

16. The method of claim 10 wherein the step of presenting comprises the step of tracking the geographic position of the mobile phone.

17. In a wireless network including an application server for providing position-based information to wireless devices, a wireless device comprising:
a position application interface adapted to establish a voice communications link with the application server for vocally transmitting a request for position-based information to the application server;
wherein the position application interface is further adapted to receive the requested position-based information from the application server through a data communications link; and
wherein the position application interface is further adapted to present a user of the wireless device with the requested position-based information.

18. The wireless device of claim 17 further comprising position determination components for calculating a current geographic position of the wireless device.

19. The wireless device of claim 18 wherein the position determination components comprise a GPS receiver.

20. The wireless device of claim 17 further comprising speech synthesis components for converting the requested position-based information to speech and audibly presenting the speech to the user.
